(19) United States
(12) Patent Application Publication
(10) Pub. No.: US 2011/0134112 A1
(43) Pub. Date: Jun. 9, 2011

(54) MOBILE TERMINAL HAVING GESTURE RECOGNITION FUNCTION AND INTERFACE SYSTEM USING THE SAME

(75) Inventors: Eun-Jin Koh, Daejeon (KR); Jong-Ho Won, Daejeon (KR); Jun-Seok Park, Daejeon (KR); Jeun-Woo Lee, Daejeon (KR)

(73) Assignee: Electronics and Telecommunications Research Institute, Daejeon (KR)

(21) Appl. No.: 12/951,930

(22) Filed: Nov. 22, 2010

(30) Foreign Application Priority Data
Dec. 8, 2009 (KR) 10-2009-0121195

(51) Int. Cl. G06T 15/00; G09G 5/00

(52) U.S. Cl. 345/419; 345/156

(57) ABSTRACT

Disclosed is an interface system including: a mobile terminal having a gesture recognition function that includes a camera capable of exchanging a filter and a controller analyzing image information provided from the camera to recognize a user's gesture and outputting a control signal corresponding to the recognized gesture; and a secondary apparatus that communicates with the mobile terminal in a short-range wireless communication method. In the interface system, the mobile terminal recognizing the user's gesture transmits the corresponding control signal to the secondary apparatus in the short-range wireless communication method so as to control the secondary apparatus.

### CROSS REFERENCE TO RELATED APPLICATIONS

This application claims priority to Korean Patent Application No. 10-2009-0121195 filed on Dec. 8, 2009, the entire contents of which are herein incorporated by reference.

### BACKGROUND OF THE INVENTION

1. Field of the Invention

The present invention relates to a mobile terminal and an interface system using the same, and more particularly, to a mobile terminal having gesture recognition function and an interface system using the same.

2. Description of the Related Art

In general, types interacting with an apparatus by recognizing a user's gesture include many fixed objects such as the interior of a vehicle or a wall. Further, most of the types interact by using a glove or a stick-type auxiliary device even though an apparatus having ensured mobility recognizes the gesture. In the type recognizing the user's gesture without an additional device, mobility cannot be ensured due to variation of recognition rate depending on an environment.

### SUMMARY OF THE INVENTION

An object of the present invention is to provide a mobile terminal capable of being controlled without directly being touched.

Another object of the present invention is to provide an interface system capable of controlling a secondary apparatus by using a mobile terminal.

Yet another object of the present invention is to provide a mobile terminal capable of outputting a control signal by recognizing a user's gesture.

Still another object of the present invention is to provide an interface system capable of controlling a secondary apparatus by using a mobile terminal capable of recognizing a user's gesture.

In order to achieve the above-mentioned object, a mobile terminal according to an embodiment of the present invention is capable of manually or automatically exchanging an infrared-ray shielding filter and a visible-ray shielding filter.

An interface system according to another aspect of the present invention includes a mobile terminal capable of recognizing a user's gesture and a secondary apparatus performing data communication with the mobile terminal in a short-range wireless communication method.

The mobile terminal according to the embodiment of the present invention includes: a camera capable of exchanging a filter; and a controller analyzing image information provided from the camera to recognize a user's gesture and outputting a control signal corresponding to the recognized user's gesture.

The mobile terminal according to the embodiment of the present invention includes an infrared lamp at a predetermined portion thereof.

In the mobile terminal according to the embodiment of the present invention, the camera includes an infrared-ray shielding filter and a visible-ray shielding filter.

In the mobile terminal according to the embodiment of the present invention, the infrared-ray shielding filter and the visible-ray shielding filter are arranged side by side and manually exchangeable by a user.

In the mobile terminal according to the embodiment of the present invention, the infrared-ray shielding filter and the visible-ray shielding filter are disposed in a circle and exchanged by a motor.

The mobile terminal according to the embodiment of the present invention further includes a short-range communication module capable of controlling a secondary apparatus positioned in a short range in a short-range wireless communication scheme.

The 3D interface system according to the embodiment of the present invention includes: a secondary apparatus where a marker is installed; and a mobile terminal recognizing the marker of the secondary apparatus by using a camera incorporated therein to determine the kind of the secondary apparatus and recognizing 3D space information with the secondary apparatus to output a control signal for the secondary apparatus.

In the 3D interface system according to the embodiment of the present invention, the secondary apparatus is a large-sized display apparatus.

In the 3D interface system according to the embodiment of the present invention, the secondary apparatus and the mobile terminal communicate with each other by a short-range wireless communication scheme.

In the 3D interface system according to the embodiment of the present invention, the mobile terminal outputs the control signal for controlling the secondary apparatus by recognizing a user's gesture.

A mobile terminal and a 3D interface system according to an embodiment of the present invention described above can have the following effects:

First, the mobile terminal may be used like a remote controller of a secondary apparatus.

Second, the mobile terminal may to be controlled without directly being touched.

Third, the secondary apparatus is wirelessly controlled by using the mobile terminal that is free from space restrictions.

### BRIEF DESCRIPTION OF THE DRAWINGS

FIG. 1 shows an example of a configuration of a mobile terminal according to an exemplary embodiment of the present invention;

FIG. 2 is a conceptual diagram of a camera capable of exchanging a filter;

FIG. 3 is a conceptual diagram showing a case in which a mobile terminal is connected with a large-sized display apparatus according to an exemplary embodiment of the present invention;

FIG. 4 is a conceptual diagram showing a case in which a mobile terminal is controlled by being connected with a secondary apparatus;

FIG. 5 is a conceptual diagram showing a case in which a secondary apparatus is controlled by recognizing a marker of the secondary apparatus;

FIG. 6 is a conceptual diagram showing a case in which an unseen marker is manufactured and a conceptual diagram showing a case in which a large-sized marker is configured in a secondary apparatus by using a plurality of small-sized markers; and

FIG. 7 is one exemplary diagram in which a marker is attached to a secondary apparatus.

### DETAILED DESCRIPTION OF THE PREFERRED EMBODIMENTS

Hereinafter, exemplary embodiment of the present invention will be described in detail with reference to the accompanying drawings. Herein, the detailed description of a related known function or configuration that may make the purpose of the present invention unnecessarily ambiguous in describing the present invention will be omitted. Exemplary embodiments of the present invention are provided so that those skilled in the art may more completely understand the present invention. Accordingly, the shape, the size, etc., of elements in the figures may be exaggerated for explicit comprehension.

Hereinafter, a mobile terminal and a 3D interface system using the same according to an embodiment of the present invention will be described in detail with reference to the accompanying drawings.

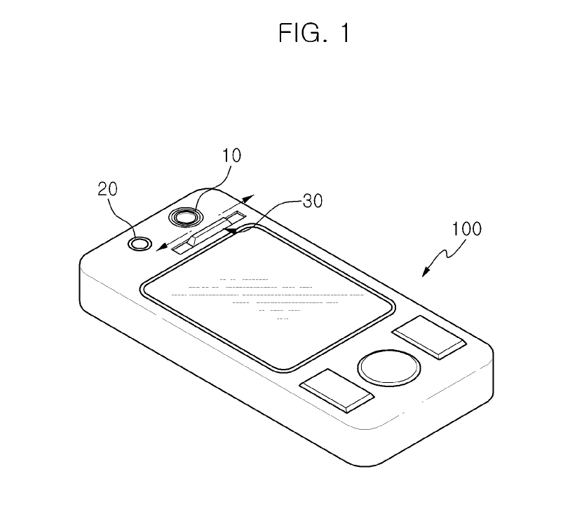

FIG. 1 is an exemplary diagram showing an exterior of a mobile terminal according to an exemplary embodiment of the present invention. As shown in the figure, in order to achieve the above-mentioned objects, the terminal 100 having ensured mobility according to the embodiment of the present invention includes a camera 10 capable of exchanging a filter and a lamp 20. Further, the terminal 100 includes a controller that analyzes image information provided from a camera 10 to recognize a user's gesture and outputs a control signal corresponding to the recognized gesture.

Although the camera is mounted on the front of the mobile terminal in FIG. 1, it is apparent that the camera may be mounted at various positions including the top, the bottom, the rear surface, etc., of the mobile terminal.

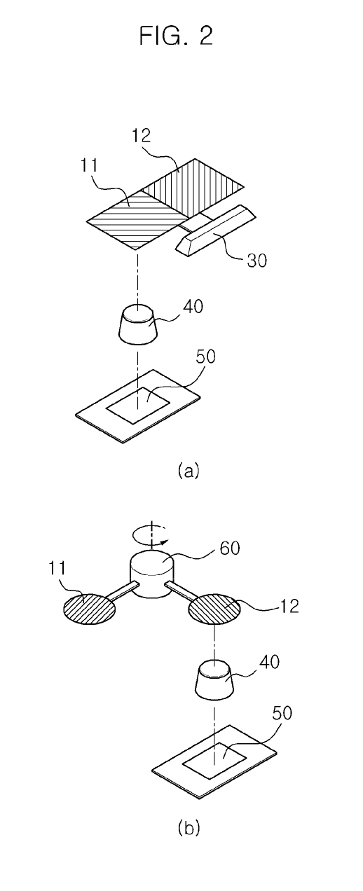

In general, since a camera of a small-sized terminal aims at photographing under a visible-ray environment, the camera cannot collect an image in an infrared-ray region. Accordingly, a camera of a type capable of manually or automatically exchanging an infrared-ray shielding filter and a visible-ray shielding filter is required as shown in FIG. 2. Although the filter is mounted outside of a lens for visibility, an exchanging sequence may be changed.

FIG. 2A shows a terminal adopting a manual exchanging type.

As shown in FIG. 2A, the infrared-ray shielding filter 11 and the visible-ray shielding filter 12 are arranged side by side in order to exchange the filters through a linear movement by using a handle 30. The lens 40 is positioned between a CCD or CMOS 50 and a selected filter 11 or 12.

Meanwhile, FIG. 2B shows an automatic filter exchanging type.

As shown in FIG. 2B, the infrared-ray shielding filter 11 and the visible-ray shielding filter 12 may be disposed in a circle. In this case, various types using a step motor or a linear motor 60 may be adopted. If the terminal is used for only gesture recognition or an additional camera aiming at photographing under the visible-ray environment is installed in the terminal, the type may be used without exchanging the filters.

In general, since infrared-rays have a short reaching distance, a part of the type close to the lamp is highlighted and the rest of the background is dark. It is possible to separate a user's predetermined body part from the background with a low computational amount while appropriately image-processing the input image. Such a method decreases the computational amount and ensures the same gesture recognition rate under almost any environments other than an outdoor environment under direct rays.

Hereinafter, in the exemplary embodiment of the present invention, it is assumed that short-range communication implemented in the terminal is Bluetooth communication. However, the short-range communication implemented in the terminal of the present invention is not limited to the Bluetooth communication type and may also adopt short-range communication types such as IrDA, UWB, NFC, etc.

Further, it will be apparent that “the mobile terminal” described in the embodiment of the present invention as a terminal for providing convenience to the user may also be applied to all information-communication apparatuses and multimedia apparatuses including a mobile communication terminal, a mobile phone, a personal digital assistant (PDA), a smart phone, a notebook, and a computer that provide short-range communication and applications thereof.

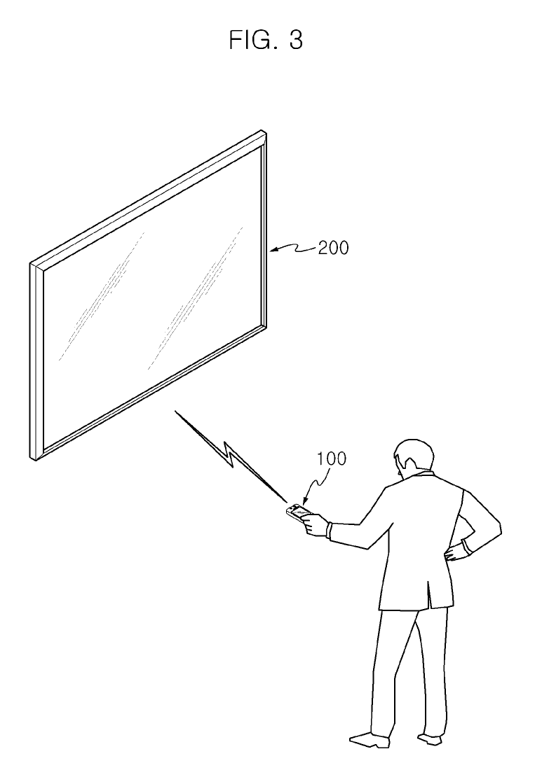

FIG. 3 is a conceptual diagram showing a case in which a mobile terminal is connected to a large-sized display according to an exemplary embodiment of the present invention.

The user connects the mobile terminal 100 with the large-sized display apparatus 200 in a wire/wireless method to display contents displayed on the mobile terminal 100 onto the large-sized display apparatus 200 as it is and in addition, may watch multimedia or perform presentations in a conference room by using the same.

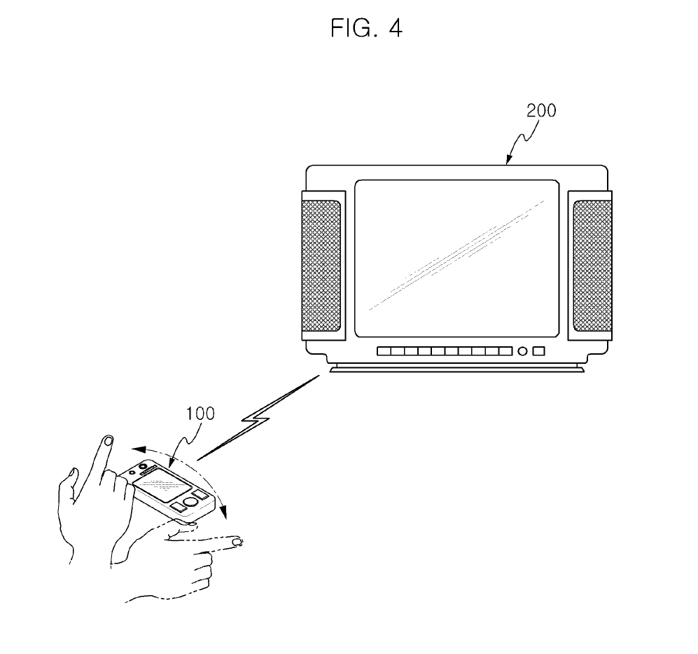

FIG. 4 is an exemplary diagram controlling a secondary apparatus by using a mobile terminal according to an exemplary embodiment of the present invention.

The user may connect the mobile terminal 100 with the secondary apparatus in the wire/wireless method by using the short-range communication and directly control the secondary apparatus 200 by using a gesture. FIG. 4 is an exemplary diagram showing a case in which an infrared camera and a small-sized apparatus with a lamp interact with each other as if leafing through the pages of a book by using a finger while being laid on a table. When the finger passes right to left, the infrared camera and the lamp may interact with each other while mapping to the next page and when the finger passes left to right, they may interact with each other while mapping to the previous page. The user may perform an interaction as if leafing the pages of the book from side to side by using only the finger without leafing through a physical book or a large motion overstraining an arm or a hand.

It will be apparent that such an interaction method is not limited to the action of leafing the pages of the book but may be used to retrieve before/after-items. Further, the interaction is available by using user's other body members or other objects as well as the finger.

As described in the embodiment, the mobile terminal is connected with home appliances such as a TV, an air-conditioner, or the like to serve as the remote controller as well as watch the multimedia or perform the presentations in the conference room. Although the control signal and operation between the mobile terminal and the secondary apparatus are directly performed in FIGS. 3 and 4, a third apparatus may be connected between the secondary apparatus and the mobile terminal.

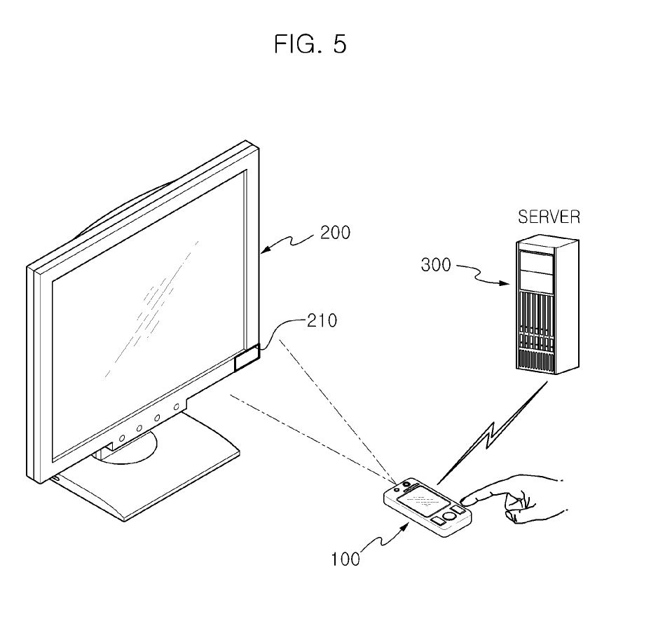

FIG. 5 is a diagram showing a case in which an apparatus is controlled by recognizing a marker 210 of a secondary apparatus 200 according to an exemplary embodiment of the present invention. When the marker 210 is attached to the secondary apparatus 200, the marker may be recognized by using the camera mounted on the mobile terminal.

The kind of the secondary apparatus 200 may be determined depending on the marker and it is possible to acquire 3D space information between the secondary apparatus 200 and the mobile terminal by using an augmented reality technique. The relative 3D space information may allow graphics augmented in the secondary apparatus 200 to be displayed on the mobile terminal or the display apparatus connected to the mobile terminal in the wire/wireless method.

Further, it is possible to control the secondary apparatus (i.e., TV) by using various interfaces including a button, a touch screen, a gesture, etc., of the mobile terminal. For example, when the user watches an IPTV, the user recognizes the 3D space information between the TV and the mobile terminal by using the mobile terminal and thereafter, the information is displayed to allow the user to easily control the TV by using the interface such as the touch screen through the mobile terminal. When the mobile terminal can recognize the marker 210, the mobile terminal 100 may receive information on the secondary apparatus 200 from a server by using the short-range communication as well as controlling the secondary apparatus 200. For example, when the user is positioned in a museum or an art gallery, the user can verify an ID of an art object by using the art object and a marker in the vicinity of the art object and receive information on the corresponding art object from the server to display the received information onto the mobile terminal.

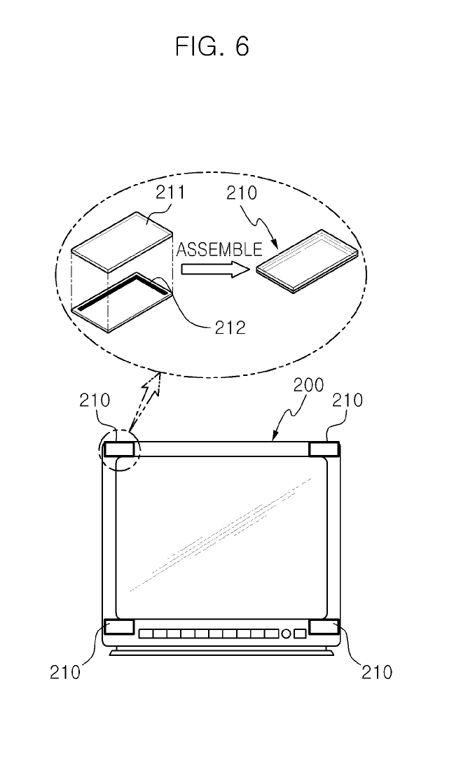

Any drawing using infrared-rays or visible-rays may be used as the marker 210 of the secondary apparatus 200, but more preferably, a type shown in FIG. 6 may be used as the marker 210. In general, since the marker has a small size, thus, is low in accuracy to be remotely used for augmented reality, but using the marker of the visible-rays may often damage the appearance of the secondary apparatus. At this time, when the marker is attached to the secondary apparatus 200 by the method shown in FIG. 6, two problems can be solved at once. Although a marker 212, which is assumed to have a ‘L’ shape is covered with a visible-ray shielding plate 211 and attached to four edges of the secondary apparatus 200, any drawing may be used as the marker. Further, although the marker is assumed to be visible and the marker is covered with the visible-ray shielding plate 211 in FIG. 6, when the marker is assumed to be invisible by using other methods such as a method of using infrared pigments or an infrared emitter for the marker itself, the visible-ray shielding plate is unnecessary.

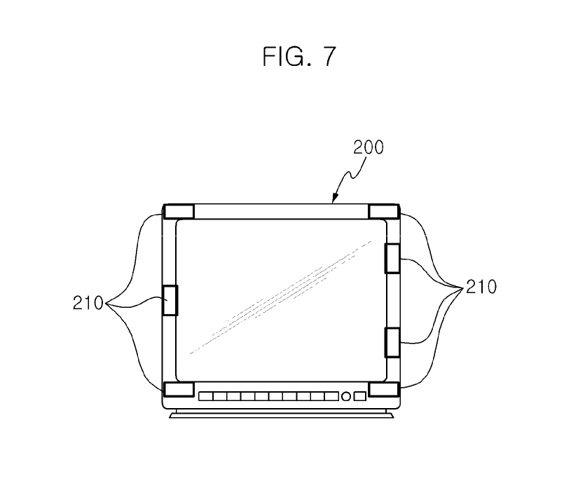

A plurality of unseen markers 210 are attached to the TV as shown in FIG. 6. Therefore, when a plurality of small-sized markers 210 are used to configure one meaning marker, the marker can be easily attached to the secondary apparatus 200 and manufacturing cost is decreased (see FIG. 7). Further, the marker may be incorporated in the apparatus at the time of manufacturing the secondary apparatus rather than manufacturing and attaching the marker to the secondary apparatus. When markers having different shapes are used for each secondary apparatus, a plurality of secondary apparatus may be discriminated and different interfaces may be provided for each secondary apparatus.

Although the camera capable of exchanging the filters may be mounted directly on the mobile terminal, the camera may be mounted on other apparatuses connected with the mobile terminal in the wire/wireless method.

However, in this case, when a use purpose of the camera mounted on the other apparatuses is determined, a simple camera incapable of exchanging the filters may be used.

It is possible to provide the same interface as that in FIGS. 4, 5, and 6 by mounting a plurality of cameras incapable of exchanging the filters on the mobile terminal. For example, assuming that one camera is an infrared-ray camera and the other camera is a visible-ray camera, augmented graphics are added to a real image of the secondary apparatus by combining images collected by two cameras to be provided to, as a GUI, a display screen of the mobile terminal or a display apparatus connected with the mobile terminal in the wire/wireless method.

Further, the unseen marker is attached to a body of the user and the user may acquire the same effect as a wearable computer by using the camera mounted on other apparatus connected with the mobile terminal in the wire/wireless method. For example, when the unseen marker is attached to a left arm of the user and an HMD mounted with the camera is connected with the mobile terminal, various kinds of information may be displayed on the HMD by using the augmented reality technique while the user sees the left arm and the marker may interact with the mobile terminal through the user's gesture.

Some steps of the present invention can be implemented as a computer-readable code in a computer-readable recording medium. The computer-readable recording media includes all types of recording apparatuses in which data that can be read by a computer system is stored. Examples of the computer-readable recording media may include a ROM, a RAM, a CD-ROM, a CD-RW, a magnetic tape, a floppy disk, an HDD, an optical disk, a magneto-optic storage device, etc., and in addition, include a recording medium implemented in a form of a carrier wave (i.e., transmission through the Internet). Further, the computer-readable recording media are distributed on computer systems connected through a network, and thus the computer-readable recording media may be stored and executed as the computer-readable code by a distribution scheme.

As described above, exemplary embodiments have been described and illustrated in the drawings and the description. Herein, specific terms have been used, but are just used for the purpose of describing the present invention and are not used for defining the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A mobile terminal having a gesture recognition function, comprising:
a camera capable of exchanging a filter; and
a controller analyzing image information provided from the camera to recognize a user's gesture and outputting a control signal corresponding to the recognized user's gesture.

2. The mobile terminal having a gesture recognition function according to claim 1, wherein the mobile terminal includes an infrared lamp at a predetermined portion thereof.

3. The mobile terminal having a gesture recognition function according to claim 1, wherein the camera includes an infrared-ray shielding filter and a visible-ray shielding filter.

4. The mobile terminal having a gesture recognition function according to claim 3, wherein the the infrared-ray shielding filter and the visible-ray shielding filter are arranged side by side and manually exchangeable by a user.

5. The mobile terminal having a gesture recognition function according to claim 3, wherein the infrared-ray shielding filter and the visible-ray shielding filter are disposed in a circle and exchanged by a motor.

6. The mobile terminal having a gesture recognition function according to claim 1, further comprising a short-range communication module controlling a secondary apparatus positioned in a short range in a short-range wireless communication scheme.

7. A 3D interface system, comprising:
a secondary apparatus where a marker is installed; and
a mobile terminal recognizing the marker of the secondary apparatus by using a camera incorporated therein to determine the kind of the secondary apparatus and recognizing 3D space information with the secondary apparatus to output a control signal for controlling the secondary apparatus.

8. The 3D interface system according to claim 7, wherein the secondary apparatus is a large-sized display apparatus.

9. The 3D interface system according to claim 7, wherein the secondary apparatus and the mobile terminal communicate with each other by a short-range wireless communication scheme.

10. The 3D interface system according to claim 7, wherein the mobile terminal outputs the control signal for controlling the secondary apparatus by recognizing a user's gesture.
